(19) United States
(12) Patent Application Publication
(10) Pub. No.: US 2009/0032752 A1
(43) Pub. Date: Feb. 5, 2009

(54) Linear solenoid

(75) Inventor: Kanehisa Nagasaki, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/078,611

(22) Filed: Apr. 2, 2008

(30) Foreign Application Priority Data
Jul. 30, 2007 (JP) 2007-197904

(51) Int. Cl. F16K 31/06

(52) U.S. Cl. 251/129.15

(57) ABSTRACT

In a linear solenoid, a plunger and a shaft axially contact with each other to transmit a drive force of the plunger to the shaft through a contact portion between the plunger and the shaft. The contact portion between the plunger and the shaft is placed between a magnetically attracting side end of the plunger and the other end of the plunger along a center axis of the plunger.

### CROSS REFERENCE TO RELATED APPLICATION

This application is based on and incorporates herein by reference Japanese Patent Application No. 2007-197904 filed on Jul. 30, 2007.

### BACKGROUND OF THE INVENTION

1. Field of the Invention

The present invention relates to a linear solenoid.

2. Description of Related Art

One known linear solenoid is of a non-slide plunger type, in which a plunger is non-slidably supported. Japanese Unexamined Patent Publication No. H09-178024 and Japanese Unexamined Patent Publication No. H11-260623 (corresponding to U.S. Pat. No. 5,861,838) disclose such a linear solenoid.

FIG. 3 shows one example of such a prior art non-slide plunger type (a type, in which a plunger is fixed to a shaft). In the following description, components, which are similar to those described in an embodiment of the present invention described below, will be indicated by the same reference numerals.

In this linear solenoid 2, a plunger 12 and a shaft 14 are securely fixed together by, for example, press fitting. One side of the shaft 14 is supported by a thrust bearing J1, and the other side of the shaft 14 is supported by a plate shaped spring member J2. The plunger 12 does not slide relative to a surrounding member (i.e., a magnetic transferring member 19).

However, in this non-slide plunger type, a hole, which receives the shaft 14, needs to be formed with high accuracy, so that the manufacturing cost is disadvantageously increased. Also, the number of components is disadvantageously increased, and the structure is disadvantageously complicated.

In view of the above disadvantages, a plunger slide type (a type, in which a shaft is independent from a plunger) has been proposed (see, for example, Japanese Unexamined Patent Publication No. 2005-233213) to simplify the structure.

FIGS. 1A and 1B show a comparative exemplary linear solenoid 2 of the plunger side type. Here, it should be noted that this linear solenoid 2 of FIGS. 1A and 1B is indicated for an illustrative purpose to illustrate characteristics of the embodiment described below and should not be considered as a prior art.

In the linear solenoid 2, a plunger 12 is slidable relative to a surrounding member (a magnetic transferring member 19 in FIG. 3), and the plunger 12 and a shaft 14 axially contact with each other. A drive force of the plunger 12 is transmitted to the shaft 14 through a contact portion X.

In the above plunger non-slide type (see FIG. 3), the shaft 14, which is securely fixed together with the plunger 12, is supported at the two sides thereof. Thus, even when tilting of the plunger 12 occurs, such tilting of the plunger 12 should be very small.

However, in the linear solenoid 2 of the plunger slide type, the plunger 12 itself slides along the surrounding member. Thus, the tilting of the plunger 12 may possibly become relatively large.

When the plunger 12 slides in the tilted state thereof, the plunger 12 may possibly be caught by, i.e., snagged by the surrounding member. In order to avoid the snagging of the plunger 12, it is effective to reduce a contact resistance in a radial direction between the plunger 12 and the shaft 14.

In view of this, it has been proposed to have a generally spherical surface in the contact surface between the plunger 12 and the shaft 14 to reduce the contact resistance in the radial direction.

A drive force of the plunger 12 and an urging force of a return spring (see reference numeral 5 in FIG. 3) are exerted at a contact portion X between the plunger 12 and the shaft 14. Specifically, axial counteracting forces (the urging force of the return spring+the drive force of the plunger 12) are exerted intensively at a magnetically attracting side front end (the left end in FIG. 1A) of the plunger 12. Thus, upon occurrence of unavoidable small misalignment between a center axis of the shaft 14 and a center axis of the plunger 12, occurrence of biasing of the magnetic attractive force (see a solid line arrow α in FIG. 1A) applied to the plunger 12, or occurrence of small tilting of the plunger 12, the above-described axial counteracting forces will provide a tilting force (see a dotted line arrow β in FIG. 1A) against the plunger 12.

The axial counteracting forces result in generation of the tilting force (the snagging force or frictional engaging force of the plunger 12) on the plunger 12, so that the slide resistance of the plunger 12 is increased. Therefore, the control performance of the plunger 12 and the spool (see reference numeral 4 in FIG. 3) is deteriorated.

Furthermore, the tilting force (the snagging force of the plunger 2) applied on the plunger 12 by the axial counteracting forces will likely increase a chance of the snagging of the plunger 12 relative to the surrounding member thereof. Thus, the malfunctioning may possibly occur.

In the above description, the disadvantages of the linear solenoid 2 are described using the solenoid spool valve as the example. However, even in the linear solenoid 2, which drives a subject element that is other than the spool valve, the tilting force of the plunger 12, which results from the contact between the plunger 12 and the shaft 14, may increase the slide resistance of the plunger 12 and may cause the increased chance of the snagging of the plunger 12 relative to the surrounding member.

### SUMMARY OF THE INVENTION

The present invention addresses at least one of the above disadvantages.

According to one aspect of the present invention, there is provided a linear solenoid, which includes a coil, a plunger, a magnetically attracting member and a shaft. The coil generates a magnetic force upon energization thereof. The plunger is made of a magnetic material and is axially slidably supported through an outer peripheral surface thereof. The magnetically attracting member magnetically attracts the plunger in an axial direction by the magnetic force, which is generated by the coil. The shaft is placed radially inward of the magnetically attracting member along a center axis of the magnetically attracting member to transmit a drive force of the plunger to outside of the linear solenoid. The plunger and the shaft axially contact with each other to transmit the drive force of the plunger to the shaft through a contact portion between the plunger and the shaft. A shaft receiving hole extends along a center axis of the plunger to receive the shaft in the plunger. The contact portion between the plunger and the shaft is placed between a magnetically attracting side end of the plunger and the other end of the plunger along the center axis of the plunger.

### BRIEF DESCRIPTION OF THE DRAWINGS

The invention, together with additional objectives, features and advantages thereof, will be best understood from the following description, the appended claims and the accompanying drawings in which:

FIG. 1A is a partial longitudinal cross sectional view of a comparative linear solenoid;

FIG. 1B is an end view of a plunger of the linear solenoid seen from a right side in FIG. 1A;

FIG. 2A is a partial longitudinal cross sectional view of a linear solenoid of an embodiment of the present invention;

FIG. 2B is an end view of a plunger of the linear solenoid seen from a right side in FIG. 2A; and

FIG. 3 is a longitudinal cross sectional view of a prior art solenoid spool valve.

### DETAILED DESCRIPTION OF THE INVENTION

Now, an embodiment of the present invention will be described with reference to the accompanying drawings.

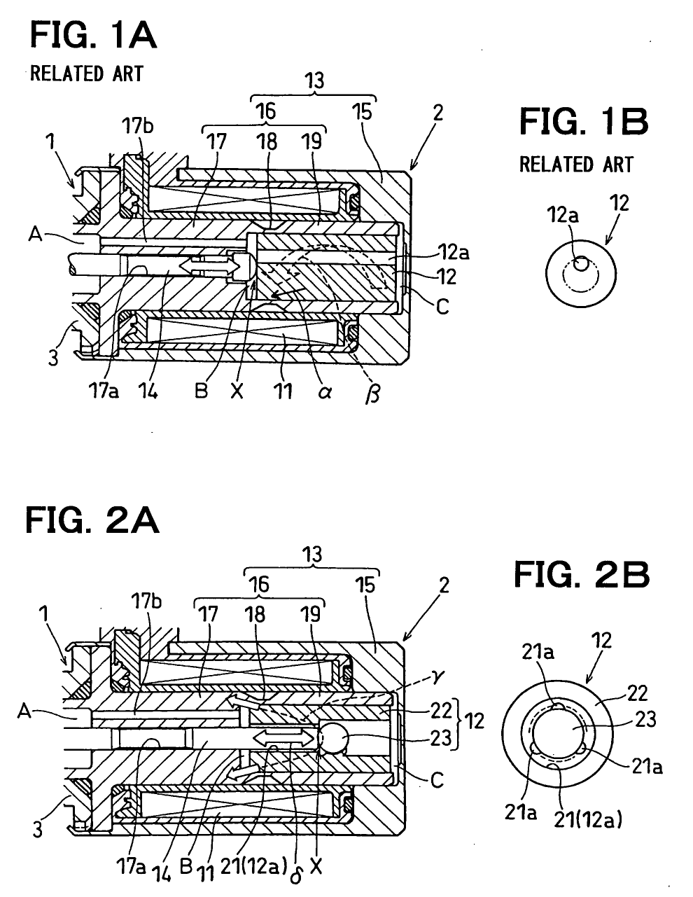

In the present embodiment, a main structure of a solenoid spool valve will be described first, and then characteristics of the present embodiment will be described. In the following description, the left side of FIGS. 1A and 2A will be referred to as a front side, and the right side of FIGS. 1A and 2A will be referred to as a rear side for the illustrative purpose. However, these terms are not related to the actual installation direction.

A solenoid valve of the present invention is installed in, for example, a hydraulic pressure control device of an automatic transmission and includes a spool valve 1 and a linear solenoid 2. The linear solenoid 2 drives the spool valve 1.

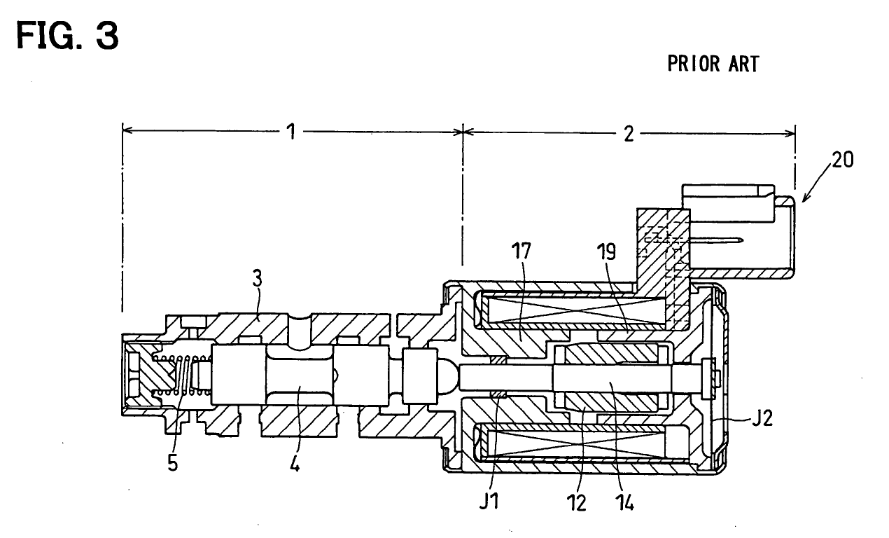

Although only an end portion of the spool valve 1 is shown in FIG. 2A, the spool valve 1 is of a known structure and includes a sleeve 3 (an example of a valve body), a spool (see reference numeral 4 of FIG. 3) and a return spring (see reference numeral 5 of FIG. 3).

The sleeve 3 has a generally cylindrical tubular configuration and is received in a hydraulic circuit body, in which oil passages are formed. Here, it should be noted that in place of the sleeve 3, the hydraulic circuit body, in which the oil passages are formed, may be used as the valve body of the present invention.

The sleeve 3 includes a receiving hole, an input port, an output port, a drain port, a feedback (F/B) port and a breathing port. The receiving hole axially slidably receives the spool. A hydraulic pressure is supplied to the input port from an oil pump (an oil pressure generating means) through an oil passage and a switch valve. An output pressure, which has been adjusted in the spool valve 1, is outputted through the output port. The drain port is communicated with a low pressure side (e.g., an oil pan). The F/B port is communicated with the output port. The breathing port is communicated with the low pressure side (e.g., the oil pan).

The axial locations of the input port, the output port, the drain port, the F/B port and the breathing port vary between a normally closed (N/C) type and a normally open (N/O) type.

The spool is axially slidably supported in the sleeve 3 and includes an input seal land, a drain seal land and an F/B land. The input seal land is provided to seal the input port, and the drain seal land is provided to seal the drain port. The F/B land has an outer diameter that is smaller than that of the input seal land. A distribution chamber is formed between the input seal land and the drain seal land, and an F/B chamber is formed between the input seal land and the F/B land.

The axial locations of the input seal land, the drain seal land and the F/B land vary between the N/C type and the N/O type.

The return spring is a coil spring, which is axially held between the spool and an adjust screw, which is threadably engaged into a threaded hole formed in a front end portion (the side opposite from the linear solenoid 2) of the sleeve 3. The return spring urges the spool toward the linear solenoid 2 side (the rear side). By adjusting an engaging amount (screwed amount) of the adjust screw, a spring load of the return spring changes.

The linear solenoid 2 includes a coil 11, a plunger 12, a magnetic stator 13, a shaft 14 and a connector.

The coil 11 generates a magnetic force upon energization thereof to create a magnetic flux loop, which flows through the plunger 12 and the magnetic stator 13. The coil 11 is formed by winding a wire (enamel wire), which is coated with a dielectric film, around a bobbin made of a resin material.

The plunger 12 is formed into a generally cylindrical body. An outer peripheral surface of the plunger 12 directly slidably engages an inner peripheral surface (specifically, an inner peripheral surface of a magnetic transferring member 19 described below) of the magnetic stator 13 and is thereby axially slidably supported therein. Details of the plunger 12 will be described more below.

The magnetic stator 13 includes a yoke 15 and a stator core 16. The yoke 15 is made of a magnetic material and covers an outer peripheral surface of the coil 11. The stator core 16 is made of a magnetic material and is received radially inward of the coil 11.

The stator core 16 is made of magnetic metal (e.g. a ferromagnetic material such as iron), which conducts the magnetic flux that passes through the interior side of the coil 11, and includes a magnetically attracting member 17, a magnetic insulation groove 18 and the magnetic transferring member 19, which are formed integrally.

The magnetically attracting member 17 is for magnetically attracting the plunger 12 in the forward direction and forms a magnetically attracting portion (a main magnetic gap) between the magnetically attracting member 17 and the plunger 12. The magnetically attracting member 17 is axially opposed to the plunger 12. A shaft slide hole 17a extends through the magnetically attracting member 17 along a center axis of the magnetically attracting member 17 and axially slidably receives the shaft 14. Furthermore, a stator breathing hole 17b extends through the magnetically attracting member 17 in parallel with the shaft slide hole 17a. The stator breathing hole 17b communicates between a low pressure communication chamber A and a plunger front chamber B. The low pressure communication chamber A communicates with the low pressure side in the spool valve 1. The plunger front chamber B is formed between the magnetically attracting member 17 and the plunger 12.

An overlapping tubular portion is provided in the magnetically attracting member 17 to receive a front end portion of the plunger 12, so that the magnetically attracting member 17 and the plunger 12 are axially partially overlapped with each other. A tapered surface is formed in an outer peripheral surface of the overlapping tubular portion of the magnetically attracting member 17 to limit a change in the magnetically attracting force with respect to the amount of stroke of the plunger 12.

The magnetic insulation groove 18 hinders or limits a direct flow of the magnetic flux between the magnetically attracting member 17 and the magnetic transferring member 19 and is formed as an annular groove that circumferentially extends between the magnetically attracting member 17 and the magnetic transferring member 19.

The magnetic transferring member 19 is formed into a cylindrical tubular body, which covers an outer peripheral surface of the plunger 12. The magnetic transferring member 19 conducts the magnetic flux to and from the yoke 15. The magnetic transferring member 19 also radially conducts the magnetic flux relative to the plunger 12, which is placed radially inward of the magnetic transferring member 19.

The yoke 15 is made of magnetic metal (e.g., a ferromagnetic material, such as iron) and is configured into a cup-shape. The yoke 15 includes a generally cylindrical tubular yoke wall, which surrounds the coil 11, and a bottom yoke wall, which closes a rear end portion of the tubular yoke wall. A rear end portion of the magnetic transferring member 19 is received in a cylindrical recess formed in a center portion of the bottom yoke wall of the yoke 15, so that the yoke 15 is magnetically coupled with the magnetic transferring member 19.

Thin walled claws are formed in a cup opening of the yoke 15. After a component (a component that is formed upon resin molding a portion of the stator core 16 and the coil 11) of the linear solenoid 2 is installed in the interior of the yoke 15, the claws of the yoke 15 are bent radially inward against the sleeve 3, so that the component of the linear solenoid 2 is securely connected to the sleeve 3.

As described above, the shaft 14 is slidably supported in the axial direction in the shaft slide hole 17a. A front end of the shaft 14 contacts a center portion (a radial center portion) of the spool, and a rear end of the shaft 14 contacts a center portion (a radial center portion) of the plunger 12. With the above construction, the plunger 12 drives the spool toward the front side through the shaft 14, and the urging force of the return spring, which is conducted to the spool, urges the plunger 12 toward the rear side.

Here, the coil 11 is connected to an electronic control unit (an undepicted AT-ECT), which controls the solenoid spool valve through a connector (see the reference numeral 20 in FIG. 3) and connection lines.

The electronic control unit performs a duty control operation of the amount of electric power supply (a current value), which is supplied to the coil 11, to control the output hydraulic pressure of the spool valve 1 by linearly changing an axial position of the plunger 12 and of the spool against the spring load of the return spring to change a degree of communication between the input port and the output port and also a degree of communication between the output port and the drain port.

As described above, in the linear solenoid 2, which is used in the solenoid spool valve, the plunger 12 and the shaft 14 contact with each other in the axial direction, so that the drive force of the plunger 12 is conducted to the spool through the shaft 14, and the urging force of the return spring, which is applied to the spool, is conducted to the plunger 12 through the shaft 14.

In the following description, the main feature of the exemplary linear solenoid 2, in which the present invention is not applied, will be described in view of FIGS. 1A and 1B. Thereafter, the main feature of the linear solenoid 2 of the embodiment of the present invention will be described with reference to FIGS. 2A and 2B.

With reference to FIGS. 1A and 1B, the plunger 12 of the exemplary linear solenoid 2 is made of magnetic metal (e.g., the ferromagnetic material such as iron, more specifically, low-carbon steel having the relatively low hardness) and is configured into a generally cylindrical body. The outer peripheral surface of the plunger 12 is axially slidably supported by the magnetic transferring member 19, as described above.

The center portion of the front end of the plunger 12 contacts the center portion of the rear end of the shaft 14.

The plunger 12 has a breathing hole 12a, which axially penetrates through the plunger 12. The plunger breathing hole 12a communicates between the plunger front chamber B and the plunger rear chamber C. The plunger front chamber B is formed between the magnetic attracting member 17 and the plunger 12. The plunger rear chamber C is formed between the plunger 12 and the bottom yoke wall of the yoke 15. Since the plunger 12 and the shaft 14 contact with each other in the axial direction, the plunger breathing hole 12a is formed at a location that is eccentric from the center axis of the plunger 12, so that the plunger breathing hole 12a is not closed by the shaft 14, as shown in FIG. 1B.

As described above, in the comparative linear solenoid 2, which has the plunger 12 that slidably engages the surrounding component (specifically, the magnetic transferring member 19), the plunger 12 may possibly slide along the surrounding component upon tilting of the plunger 12. When the plunger 12 slides in the tilted state, the outer peripheral part of the plunger 12 may possibly be caught by, i.e., snagged by the magnetic transferring member 19, which surrounds the plunger 12. In order to limit the snagging of the plunger 12, a generally spherical surface is provided in the rear end (the contact surface that contacts the plunger 12) of the shaft 14, so that a contact resistance in the radial direction between the plunger 12 and the shaft 14 is reduced.

The drive force of the plunger 12 and the urging force of the return spring are exerted at the contact portion X between the plunger 12 and the shaft 14. Specifically, the axial counteracting forces (the urging force of the return spring+the drive force of the plunger 12) are exerted intensively at the front end of the plunger 12. Thus, upon occurrence of unavoidable small misalignment between the center axis of the shaft 14 and the center axis of the plunger 12, occurrence of biasing of the magnetic attractive force (see the solid line arrow α in FIG. 1A) applied to the plunger 12, or occurrence of small tilting of the plunger 12, the above-described axial counteracting forces will provide the tilting force (see the dotted line arrow β in FIG. 1A) against the plunger 12.

The tilting force, which is applied to the plunger 12, may cause an increase in the slide resistance of the plunger 12, so that the accurate control of the axial position of the plunger 12 and the spool becomes difficult. Furthermore, the tilting force, which is applied to the plunger 12, may cause the snagging of the plunger 12 relative to the magnetic transferring member 19.

As described above, the low-carbon steel (soft steel), which has the relatively low hardness, is used as the material of the plunger 12.

A hard material (e.g., stainless steel) is used as the material of the shaft 14 to increase the abrasion resistance of the shaft 14 relative to the spool and the magnetically attracting member 17.

Thus, when the plunger 12 is rattled, for example, due to excess vibrations applied from its surrounding environment or due to surges in the working fluid applied to spool 1, the contact surface pressure between the plunger 12 and the shaft 14 may possibly exceed an allowable stress of the ferromagnetic metal used in the plunger 12 to cause deformation or wearing at the contact portion of the plunger 12, which contacts the shaft 14. When the deformation or the wearing occurs at the contact portion of the plunger 12, the axial length of the plunger 12 and/or of the shaft 14 may possibly change, or the contact surface area between the plunger 12 and the shaft 14 may possibly increase. When this happens, the performance of the linear solenoid 2 may possibly be deteriorated.

As described above, the shaft 14 contacts the center portion (radial center portion) of the plunger 12, so that the plunger breathing hole 12a, which communicates between the plunger front chamber B and the plunger rear chamber C, needs to be formed at the location which is eccentric to the center axis of the plunger 12. The plunger 12 of the above type (having the shaft 14 directly contacting the center portion of the plunger 12, and the plunger breathing hole 12a being eccentric to the center axis of the plunger 12) is difficult to form through a relatively inexpensive cold forging process. Thereby, it is required to form the plunger breathing hole 12a through a relatively expensive drilling process. As a result, the manufacturing cost of the plunger 12 is disadvantageously increased.

Furthermore, the plunger breathing hole 12a, which is formed at the location that is eccentric from the center axis of the plunger 12, is placed in the magnetic path, so that the magnetic loss occurs to disadvantageously reduce the magnetic attractive force of the plunger 12.

Furthermore, the breathing hole 12a, which is eccentric to the center axis of the plunger 12, causes the biasing of the magnetic attractive force (see the solid line arrow α in FIG. 1A), which is exerted in the plunger 12, to result in the tilting of the plunger 12.

As described above, in the linear solenoid 2 of the present embodiment, the plunger 12 axially contacts the shaft 14, and the drive force is transmitted through the contact portion X. In order to address the above disadvantage, the linear solenoid 2 of the present embodiment has the following characteristic technical features.

In the linear solenoid 2 of the present embodiment, a shaft receiving hole 21 extends along the center axis in the plunger 12 to receive the shaft 14.

Furthermore, the contact portion X, at which the plunger 12 and the shaft 14 contact with each other, is located along the center axis of the plunger 12 and is spaced away from the magnetically attracting side distal end (front end) of the plunger 12 on a side (rear side) opposite from the magnetically attracting side of the plunger 12. Specifically, in the present embodiment, the contact portion X, at which the plunger 12 and the shaft 14 contact with each other, is located at an axial center portion of the plunger 12 between the magnetically attracting side distal end (the left end in FIG. 2A) of the plunger 12 and the other end (the right end in FIG. 2A) of the plunger 12.

Now, the first technical feature of the present embodiment will be described in detail.

The plunger 12 of the present embodiment includes a plunger main body 22 and a contact member 23. The plunger main body 22 is made of the magnetic metal (e.g., the ferromagnetic material such as iron, specifically, the low-carbon steel having the relatively low hardness) and is configured into a generally cylindrical tubular body. The plunger main body 22 has the shaft receiving hole 21, which extends through the plunger main body 22 along the center axis of the plunger main body 22. The contact member 23 contacts the shaft 14 in the shaft receiving hole 21.

The contact member 23 is formed separately from the plunger main body 22. The contact member 23 is installed in the shaft receiving hole 21 such that backward movement of the contact member 23 from a predetermined location (installation location) is limited by using a conventional technique (e.g., engagement, press fitting, staking). Specifically, in the present embodiment, in comparison to a front side portion (a small diameter portion) of the shaft receiving hole 21, a rear side portion (a large diameter portion) of the shaft receiving hole 21 has an enlarged inner diameter. The contact member 23 is installed into the shaft receiving hole 21 from the rear side of the shaft receiving hole 21. In an urged state where the contact member 23 is urged against a step between the small diameter portion and the large diameter portion in the shaft receiving hole 21, a portion of the plunger 12 is plastically deformed against the contact member 23 to fix the contact member 23 in the shaft receiving hole 21.

The contact member 23 is the separate component, which is produced separately from the plunger main body 22, so that there is a more freedom in terms of selection of the material and the configuration of the contact member 23. Thus, the contact member 23 of the present embodiment is made of a harder material (having a higher resistivity against deformation and wearing) in comparison to the material of the plunger main body 22. Specifically, the contact member 23 is made of the material (e.g., stainless steel), which has the hardness that is generally the same as that of the material of the shaft 14.

In the exemplary linear solenoid 2 shown in FIG. 1A, the rear end (the contact portion that contacts the plunger 12) of the shaft 14 has the generally spherical surface, so that the contact resistance in the radial direction between the plunger 12 and the shaft 14 is reduced.

In contrast, according to the present embodiment, a generally spherical surface, which is convexly bulged toward the contacting direction, is formed in the contact portion X, at which the plunger 12 and the shaft 14 contact with each other. Specifically, in the present embodiment, the shaft 14 contacts the contact member 23, so that the contact portion of the contact member 23, which contacts the shaft 14, is formed to have the generally spherical surface. Further specifically, in the present embodiment, the contact member 23 is formed as a generally spherical ball, which is made of the hard material (e.g., stainless steel).

The ball, which has the high universal versatility (i.e., used in many marketed products), is used as the contact member 23, so that the cost, which is required to make the generally spherical surface at the contact portion between the plunger 12 and the shaft 14, can be reduced or limited.

Furthermore, as discussed above, the shaft receiving hole 21 of the present embodiment is the through hole, which axially penetrates through the plunger 12. Thus, the shaft receiving hole 21 is used as the plunger breathing hole 12a, which communicates between the spaces (the plunger front chamber B and the plunger rear chamber C) located at the axial ends, respectively, of the plunger 12.

A gap is formed between the inner peripheral surface of the shaft receiving hole 21 and the contact member 23 to communicate between the spaces located at the axial ends, respectively, of the plunger 12. Thus, the communication between the opposed ends of the shaft receiving hole 21 is not hindered by the contact member 23 installed into the shaft receiving hole 21.

Specifically, in the present embodiment, as shown in FIG. 2B, at least one axially extending breathing groove 21a (three breathing grooves 21a in the present instance) is provided as the example of the gap along the inner peripheral surface of the shaft receiving hole 21 at the location where the ball is fixed in the shaft receiving hole 21. Thus, the axial ends of the shaft receiving hole 21 are communicated with each other through the breathing grooves 21a.

In a case where there is a high possibility of that the plunger 12 contacts the magnetically attracting member 17 upon increasing of the magnetic force of the coil 11, it is desirable to provide a preventive measure to limit the magnetic contact between the plunger 12 and the magnetically attracting member 17. The preventive measure for limiting the magnetic contact between the plunger 12 and the magnetically attracting member 17 may be as follows. For example, a non-magnetic plate may be placed between the plunger 12 and the magnetically attracting member 17, or as described with reference to the exemplary linear solenoid 2 of FIGS. 1A and 1B, the enlarged hole may be formed in the shaft slide hole 17a at the rear portion of the shaft 14 to limit the forward movement of the shaft 14 beyond the predetermined distance.

In the linear solenoid 2 installed in the solenoid spool valve of the present embodiment, the plunger 12 and the shaft 14 axially contact with each other, and the plunger 12 slidably engages the magnetic transferring member 19.

In the linear solenoid 2 of the present embodiment, as discussed above, the shaft receiving hole 21, which receives the shaft 14, extends along the center axis of the plunger 12. Furthermore, the contact portion X (the axial torque transmitting portion) between the plunger 12 and the shaft 14 is located on the other side of the magnetically attracting distal end of the plunger 12, which is opposite from the magnetically attracting side of the plunger 12 along the center axis of the plunger 12.

Therefore, the contact portion X between the plunger 12 and the shaft 14 is spaced from the point of action of the plunger 12 (the annular portion at the front end of the plunger 12), which is magnetically attracted, on the other side (the rear side) in the pushing direction of the shaft 14.

Thus, in the plunger 12, a separating force (see a dotted line γ in FIG. 2A) is exerted between the point of action, which is magnetically attracted, and the contact portion X, at which the plunger 12 and the shaft 14 contact with each other. This separating force provides a tilt correcting force (see an arrow δ in FIG. 2A), which acts on the plunger 12 to limit or alleviate the tilting of the plunger 12.

As described above, although the axial counteracting forces are generated at the contact portion X between the plunger 12 and the shaft 14, the tilting of the plunger 12 is limited by using the axial counteracting forces. When the tilting of the plunger 12 is limited by adapting the above-described structure, which limits the tilting of the plunger 12 through use of the axial counteracting forces, it is possible to reduce the slide resistance of the plunger 12.

Furthermore, the shaft receiving hole 21, which functions as the plunger breathing hole 12a, is formed to extend along the center axis of the plunger 12, so that the biasing of the magnetic attractive force, which acts on the plunger 12, does not occur. Furthermore, the point of action of the plunger 12, which is magnetically attracted, exists as the annular form (ring form) at the front end of the plunger 12, and the contact portion X between the plunger 12 and the shaft 14 is located along the center axis of the plunger 12. In this way, the center axis of the plunger 12 is adjusted to generally coincide with the center axis of the magnetically attracting member 17 by the magnetic attractive force, which acts on the plunger 12.

That is, the plunger 12 receives the center axis adjusting force for adjusting the center axis of the plunger 12 in addition to the above-described tilt correcting force. Therefore, the slide resistance of the plunger 12 is limited to the relatively small value due to the tilt correcting force and the center axis adjusting force applied to the plunger 12. Since the slide resistance of the plunger 12 is limited to the relatively small value, it is possible to increase the control accuracy of the axial position of the plunger 12 and of the spool. As a result, the accurate output hydraulic pressure control operation (or the accurate output fluid quantity control operation) can be performed. Also, since the tilting of the plunger 12 is limited, it is possible to avoid or limit the snagging of the plunger 12 relative to the magnetic transferring member 19, which surrounds the plunger 12. As a result, it is possible to increase the reliability of the solenoid spool valve.

In the present embodiment, the generally spherical ball is used as the contact member 23. Therefore, the tilting of the plunger 12 about the contact portion X is eased. As a result, it is possible to increase the tilt correcting capability of the plunger 12 with use of the tilt correcting force described above.

Furthermore, since the generally spherical ball is used as the contact member 23, it is possible to reduce or limit the contact resistance in the radial direction between the plunger 12 and the shaft 14. In this way, the radial movement of the plunger 12 is eased, so that the center axis adjusting capability of the plunger 12 can be improved through use of the center axis adjusting force described above in view of the advantage of the present embodiment.

Furthermore, even in the case where the plunger 12 slides upon tilting of the plunger 12 caused by some reasons, the plunger 12 can be easily returned to the side where the tilting of the plunger 12 is limited or alleviated due to the relatively small contact resistance in the radial direction between the plunger 12 and the shaft 14. As a result, it is possible to avoid or limit the snagging of the plunger 12 relative to the magnetic transferring member 19, which surrounds the plunger 12. Thereby, it is possible to increase the reliability of the solenoid spool valve.

In the plunger 12 of the present embodiment, the plunger main body 22, which is made of the magnetic material, is formed separately from the contact member 23, which contacts the shaft 14, and is thereafter assembled together with the contact member 23.

In the case where the plunger main body 22 and the contact member 23 are formed separately and thereafter assembled together, the material and the shape of the contact member 23 can be more freely selected. Specifically, as described above, it is possible to form the contact member 23 using the harder material, which is harder than that of the plunger main body 22, and it is also possible to limit the manufacturing cost by using the ball that has the high universal versatility, i.e., that can be purchased at the low cost.

Also, in the case where the contact member 23 is made of the hard material, it is possible to limit the deformation and the wearing at the contact portion between the plunger 12 and the shaft 14. As a result, it is possible to limit the deterioration of the performance of the linear solenoid 2 for the relatively long time. Thereby, it is possible to increase the reliability of the solenoid spool valve.

The shaft receiving hole 21 of the present embodiment is the through hole, which axially penetrates through the plunger 12. Thus, the shaft receiving hole 21 is used as the plunger breathing hole 12a, which communicates between the spaces (the plunger front chamber B and the plunger rear chamber C) located at the axial ends, respectively, of the plunger 12.

The shaft receiving hole 21, which is used as the plunger breathing hole 12a, extends along the center axis of the plunger 12, so that the plunger breathing hole 12a is not placed in the magnetic path. Therefore, it is possible to avoid the magnetic loss, which would be otherwise caused by the placement of the plunger breathing hole 12a in the magnetic path. As a result, it is possible to increase the magnetic attractive force of the plunger 12.

Furthermore, the shaft receiving hole 21, which is used as the plunger breathing hole 12a, extends along the center axis of the plunger 12, so that it is possible to limit the magnetic loss. Thus, it is possible to increase the inner diameter of the shaft receiving hole 21. In this way, the plunger 12 can be formed by the rather inexpensive cold forging process instead of the expensive cutting and drilling process, so that the manufacturing cost can be reduced. Therefore, the cost of the linear solenoid 2 can be limited. As a result, the cost of the solenoid spool valve can be limited.

Now, modifications of the above embodiment will be described.

In the above embodiment, the contact member 23 (the ball in the above embodiment) is installed into the shaft receiving hole 21 from the rear side of the shaft receiving hole 21. Alternatively, the inner diameter of the front side of the shaft receiving hole 21 may be increased, and the contact member 23 may be installed into the shaft receiving hole 21 from the front side of the shaft receiving hole 21 until the contact member 23 engages the step formed in the shaft receiving hole 21. In such a case, the contact member 23 may be fixed to the plunger main body 22, or alternatively the contact member 23 may be urged against the step in the shaft receiving hole 21 by use of the urging force of the shaft 14 to fix the contact member 23 in the shaft receiving hole 21.

In the above embodiment, the ball is used as the example of the contact member 23. Alternatively, the contact member 23 may have any other member of any other suitable shape, such as a generally semispherical member or a plate member.

Furthermore, in a case where the contact surface of the contact member 23, which contacts the shaft 14, is a flat surface, it is desirable to form a generally spherical surface at the rear end of the shaft 14.

In the above embodiment, the breathing grooves 21a are formed along the inner peripheral surface of the shaft receiving hole 21, which axially extends through the plunger 12, to communicate between the opposed ends of the shaft receiving hole 21. Alternatively, for example, a communication hole(s), a slit(s) or a groove(s) may be provided in the contact member 23 to communicate between the opposed ends of the shaft receiving hole 21. Furthermore, the contact member 23 may be configured such that the contact member 23 viewed from the axial direction forms a straight line shape, a crisscross shape or a triangular shape to communicate between the opposed ends of the shaft receiving hole 21.

In the present embodiment, the plunger 12 includes the plunger main body 22 and the contact member 23, which are assembled together. Alternatively, the function of the contact member 23 may be implemented in the plunger 12, and thereby the contact member 23 may be eliminated. Specifically, the contact portion, which contacts the shaft 14, may be provided in the plunger 12 made of iron. More specifically, for example, the front side of the shaft receiving hole 21, which is formed as the through hole, may be enlarged, and the thus formed step in the shaft receiving hole 21 may contact the shaft 14. Alternatively, the shaft receiving hole 21 may be provided only to the front half of the plunger 12, and the bottom wall of the shaft receiving hole 21 may contact the shaft 14.

In the above embodiment, the contact portion X between the plunger 12 and the shaft 14 is provided in the axial center portion of the plunger 12. However, as long as the contact portion X is located on the rear side of the plunger front end (the portion that is magnetically attracted), the contact portion X can be provided to any other suitable location.

In the above embodiment, the magnetically attracting member 17, the magnetic insulation groove 18 and the magnetic transferring member 19 are formed integrally. Alternatively, the magnetically attracting member 17 and the magnetic transferring member 19 may be formed separately (see, for example, FIG. 3).

In the above embodiment, the plunger 12 slides directly along the magnetic transferring member 19. Alternatively, a cup member, which is made of thin walled metal (e.g., stainless steel), may be placed between the plunger 12 and magnetic transferring member 19, and the plunger 12 may slide along an inner peripheral surface of the cup member.

In the above embodiment, the spool valve 1 is driven by the linear solenoid 2. Alternatively, the present invention may be applied to the linear solenoid 2, which drives a valve device having a ball valve or any other valve structure in place of the spool valve 1.

In the above embodiment, the three-way switch valve structure is shown and described as the example of the valve device. Alternatively, the present invention may be applied to the linear solenoid 2 that drives the valve device having the valve structure, which is a two-way valve (opening and closing valve) or four or more-way valve.

In the above embodiment, the present invention is applied to the solenoid spool valve, which is applied to the hydraulic pressure control device of the automatic transmission. Alternatively, the present invention may be applied to a solenoid spool valve (e.g., an oil flow control valve, such as an oil flow control valve of the well known VVT that varies the advance angle of the camshaft) of any other system other than the automatic transmission.

In the above embodiment, the present invention is applied to the linear solenoid 2, which drives the valve device (the spool valve 1 in the above embodiment). Alternatively, the present invention may be applied to the linear solenoid 2, which directly or indirectly drives a driven element (subject element) other than the valve.

Additional advantages and modifications will readily occur to those skilled in the art. The invention in its broader terms is therefore not limited to the specific details, representative apparatus, and illustrative examples shown and described.

What is claimed is:

1. A linear solenoid comprising:
a coil that generates a magnetic force upon energization thereof;
a plunger that is made of a magnetic material and is axially slidably supported through an outer peripheral surface thereof;
a magnetically attracting member that magnetically attracts the plunger in an axial direction by the magnetic force, which is generated by the coil; and
a shaft that is placed radially inward of the magnetically attracting member along a center axis of the magnetically attracting member to transmit a drive force of the plunger to outside of the linear solenoid, wherein:
the plunger and the shaft axially contact with each other to transmit the drive force of the plunger to the shaft through a contact portion between the plunger and the shaft;
a shaft receiving hole extends along a center axis of the plunger to receive the shaft in the plunger; and
the contact portion between the plunger and the shaft is placed between a magnetically attracting side end of the plunger and the other end of the plunger along the center axis of the plunger.

2. The linear solenoid according to claim 1, wherein one of a contact surface of the plunger and a contact surface of the shaft at the contact portion is a generally spherical surface that is convexly bulged toward the other one of the contact surface of the plunger and the contact surface of the shaft in a contact direction thereof.

3. The linear solenoid according to claim 1, wherein the plunger includes:
a plunger main body that is made of a magnetic material; and
a contact member that contacts the shaft at the contact portion and is assembled together with the plunger main body.

4. The linear solenoid according to claim 3, wherein the contact member is made of a harder material, which is harder than the magnetic material of the plunger main body.

5. The linear solenoid according to claim 4, wherein the contact member is a ball, which is configured into a generally spherical shape and is fixed in the shaft receiving hole.

6. The linear solenoid according to claim 3, wherein:
the shaft receiving hole is a through hole that axially penetrates through the plunger; and
the shaft receiving hole communicates between first and second spaces, which are located at the ends, respectively, of the plunger, through at least one gap, which is formed between an inner peripheral surface of the shaft receiving hole and the contact member.

7. The linear solenoid according to claim 6, wherein the shaft receiving hole has:
a small diameter portion that has a first inner diameter; and
a large diameter portion that receives the contact member and has a second inner diameter, which is larger than the first inner diameter.

8. The linear solenoid according to claim 1, wherein:
the linear solenoid is adapted to connect with a spool valve, which includes a valve body, a spool and a return spring; and
an urging force of the return spring is applied to the plunger through the spool and the shaft.
